(19) United States
(12) Patent Application Publication
(10) Pub. No.: US 2012/0236561 A1
(43) Pub. Date: Sep. 20, 2012

(54) LIGHTING UNIT

(76) Inventor: Yoshiaki Nakaya, Tokyo (JP)

(21) Appl. No.: 13/420,598

(22) Filed: Mar. 14, 2012

(30) Foreign Application Priority Data
Mar. 14, 2011 (JP) 2011-055622
Mar. 14, 2011 (JP) 2011-055623

(51) Int. Cl. F21V 13/04; F21V 5/04

(52) U.S. Cl. 362/247; 362/311.01; 362/308

(57) ABSTRACT

A projector type lighting unit can include a projection lens having an optical axis, a rear-side focal point positioned on the optical axis, an incident surface, and an exiting surface. A light source can be disposed on or near the focal position of the projection lens, and an image of the light source can be projected through the projection lens. A light path adjusting unit can be configured to diffuse part of the image of the light source in an upward direction when the lighting unit is installed in a vehicle light. The light path adjusting unit can be disposed in between the projection lens and the rear-side focal point of the projection lens, and can be a reflector having a planar mirror inclined with respect to a plane perpendicular to the optical axis of the projection lens toward the projection lens by about 45 degrees.

This application claims the priority benefit under 35 U.S.C. §119 of Japanese Patent Applications Nos. 2011-055622 filed on Mar. 14, 2011 and 2011-055623 filed on Mar. 14, 2011, which are hereby incorporated in their entireties by reference.

### TECHNICAL FIELD

The presently disclosed subject matter relates to a lighting unit, and in particular, to a lighting unit that can form a light distribution pattern extending in the vertical direction.

### BACKGROUND ART

Conventional vehicle lighting units configured to form a light distribution pattern by projecting a light source image have been known (see, for example, Japanese Patent Application Laid-Open No. 2009-070679). FIG. 1 shows the vehicle lighting unit 200 described in Japanese Patent Application Laid-Open No. 2009-070679. The vehicle lighting unit 200 can include a plurality of cylindrical members 210 an inner peripheral surface of which has been subjected to minor finishing, reflectors 220 provided to respective cylindrical members 210 at the deepest ends, light-emitting devices 230 provided near the respective reflectors 220, and a projection lens 240. The light emitted from the light-emitting devices can enter the respective reflectors 220 to be reflected by the same. Then, the reflected light can enter the inside of the cylindrical members 210 from one ends 212 of the cylindrical members 210 while being reflected by the inner peripheral surface 211 with the minor surface, thereby exiting through the other ends 213 (light exiting openings) of the cylindrical members 210. The light exiting openings 213 of the plurality of cylindrical members 210 can be disposed at or near the rear-side focal point of the projection lens 240, whereby a uniform luminance distribution (light image) is formed at the light exiting openings 213. The image formed at the light exiting openings 213 can be reversed and projected by the projection lens 240, thereby forming a desired light distribution pattern. The shape of the light distribution pattern can be adjusted by the shape of the light exiting openings 213 of the cylindrical members 210 to some extent. However, in this configuration, light that cannot enter the inside of the cylindrical members 210 and the lens 240 may increase, thereby deteriorating the light utilization efficiency. Accordingly, the light may not be diffused into a desired direction.

### SUMMARY

The presently disclosed subject matter was devised in view of these and other problems and features and in association with the conventional art. According to an aspect of the presently disclosed subject matter, a lighting unit can form a vertically long light distribution pattern without lowering the light utilization efficiency.

According to another aspect of the presently disclosed subject matter, a projector type lighting unit can be utilized as a vehicle headlamp, for example. The projector type lighting unit can include: a projection lens having an optical axis and a rear-side focal point positioned on the optical axis, and an incident surface and an exiting surface; a light source disposed on or near (i.e., substantially at) the focal position of the projection lens, an image of the light source being projected through the projection lens; and a light path adjusting unit configured to diffuse part of the image of the light source in an upward direction when the lighting unit is installed in a vehicle light. In the lighting unit with the above configuration, the light path adjusting unit can be disposed in between the projection lens and the rear-side focal point of the projection lens, and can be a reflector having a planar minor inclined with respect to a plane perpendicular to the optical axis of the projection lens toward the projection lens by about 45 degrees. Further, the light source can be disposed at or near (i.e., substantially at) a position that is plane-symmetrical to the rear-side focal point with respect to the planar minor, and the reflector can include a reflection area concavely curved with respect to the light source to diffuse an upper portion of the image of the light source to be projected by the projection lens upward. With the lighting unit having the above configuration, the action of the light path adjusting unit (in particular, the curved reflection area) can diffuse the upper portion of the light source to be projected by the projection lens. The diffused upper portion of the light source image can assist to form the longitudinally long light distribution pattern on a virtual vertical screen without lowering the light utilization efficiency. In the lighting unit with the above configuration, the light path adjusting unit can be configured as the projection lens including a standard lens surface with a given curvature disposed on an upper side of the projection lens with respect to a boarder as a horizontal plane including the optical axis of the projection lens and a gradually varied lens surface disposed on a lower side of the projection lens. The gradually varied lens surface can be configured such that a plurality of curvatures of curves appear on crossing lines between a plurality of planes and the gradually varied lens surface, the plurality of planes including the optical axis of the projection lens and inclined by different inclined angles with respect to a vertical plane including the optical axis of the projection lens, and the plurality of curvatures can be equal to or lower than a curvature of the standard lens surface and can gradually increase from the vertical plane to the horizontal plane. In the above configuration, the action of the gradually-varied lens surface can diffuse the upper portion of the light source image to be projected by the projection lens upward. The diffused upper portion of the light source image can assist to form the longitudinally long light distribution pattern on a virtual vertical screen without lowering the light utilization efficiency. In the lighting unit with the above configuration, the light source can include a plurality of tube portions having one end as an inlet and the other end as an outlet, and a reflector formed on an inner peripheral surface; and a plurality of light-emitting devices each configured to emit light entering the tube portion via the inlet and exiting through the outlet. The outlets of the plurality of tube portions can be arranged side by side in line in a direction perpendicular to the optical axis of the projection lens and in a horizontal direction and disposed at or near the rear-side focal point of the projection lens. Adjacent outlets among the outlets of the plurality of tube portions can include a common edge wall that partitions the outlets. The plurality of tube portions can be configured to have a pyramidal shape narrowed from the outlet to the inlet.

In the above configuration, the partition between the adjacent outlets is not formed of a thick wall portion, but an edge wall with almost negligible width. Accordingly, the plurality of outlets partitioned by the thin edge wall (or luminance distribution formed by the outlets) can be projected forward by the action of the projection lens. This can prevent or lower the gap (or darkened area) between the plurality of irradiated areas that can be adjusted by individually controlling the light-emitting devices. In the lighting unit with the above configuration, the plurality of tube portions each can be composed of a solid lens body with a pyramidal shape having one end face as the inlet and the other end face as the outlet, and an outer peripheral surface an inside surface of which can serve as the reflector, and narrowed from the outlet to the inlet. In the above configuration, the partition between the adjacent outlets (the adjacent other end faces) is not formed of a thick wall portion, but an edge wall with almost negligible width. Accordingly, the plurality of outlets partitioned by the thin edge wall (or luminance distribution formed by the other end faces) can be inverted and projected forward by the action of the projection lens. This can prevent or lower the gap (or darkened area) between the plurality of irradiated areas that can be adjusted by individually controlling the light-emitting devices. As described, the lighting unit can form a vertically long light distribution pattern without lowering the light utilization efficiency.

### BRIEF DESCRIPTION OF DRAWINGS

These and other characteristics, features, and advantages of the presently disclosed subject matter will become clear from the following description with reference to the accompanying drawings, wherein:

FIG. 1 is a cross-sectional view of a conventional vehicle lighting unit;

FIG. 2 is a horizontal cross-sectional view of a vehicle lighting unit on the right side, including a lighting unit according to one exemplary embodiment made in accordance with principles of the presently disclosed subject matter;

FIG. 3 is a perspective view of the lighting unit;

FIG. 4 is a longitudinal cross-sectional view of the lighting unit;

FIG. 5A is a view showing the light distribution pattern formed based on the light source image reflected by a planar mirror and projected by the projection lens (images of respective outlets as the light sources), and FIG. 5B is a view showing the light distribution pattern formed based on the light source image reflected by a planar mirror and projected by the projection lens (images of respective outlets as the light sources);

FIGS. 6A, 6B, and 6C are a cross-sectional view of a light source unit shown in FIG. 6B taken along line A-A, a front view, and a cross-sectional view of the light source unit shown in FIG. 6B taken along line B-B;

FIG. 7 is a view illustrating the relationship between the light from the light-emitting device and a projection lens;

FIG. 8 is an enlarged view of the portion encircled in FIG. 4;

FIG. 9A is a horizontal cross-sectional view of a mirror image of the light source unit assumed to be disposed at or near the rear-side focal point of the projection lens, and FIG. 9B is an enlarged view of the portion encircled in FIG. 9A;

FIG. 10A is a view showing a light distribution pattern P2 formed by a lighting unit dedicated to form a low beam, FIG. 10B is a view showing a light distribution pattern P1L formed by a lighting unit on the left side, FIG. 10C is a view showing a light distribution pattern P1R formed by a lighting unit on the right side, and FIG. 10D is a view showing a synthesis light distribution pattern formed by overlaying the respective light distribution patterns P1L, P1R, and P2;

FIG. 11A is a view showing a synthesis light distribution pattern formed when the light-emitting device corresponding to the area to be illuminated covering an opposed vehicle V (or preceding vehicle) positioned farther is turned off or is adjusted with reduced power, FIG. 11B is a view showing a synthesis light distribution pattern formed when the light-emitting device corresponding to the area to be illuminated covering an opposed vehicle V (or preceding vehicle) positioned farther is turned off or is supplied with adjusted power, and FIG. 11C is a view showing a synthesis light distribution pattern formed when the light-emitting device corresponding to the area to be illuminated covering an opposed vehicle V (or preceding vehicle) positioned farther is turned off or is supplied with adjusted power;

FIG. 12 is a view showing a modification of a light guide member;

FIG. 13 is a horizontal cross-sectional view showing a vehicle light on the right side, including a lighting unit according to one exemplary embodiment made in accordance with principles of the presently disclosed subject matter;

FIG. 14 is a perspective and partial cutaway view of the lighting unit of FIG. 13;

FIG. 15 is an exploded perspective view of the lighting unit of FIG. 13;

FIG. 16A is a top view of the lighting unit of FIG. 13, FIG. 16B is a front view thereof, and FIG. 16C is a side view thereof;

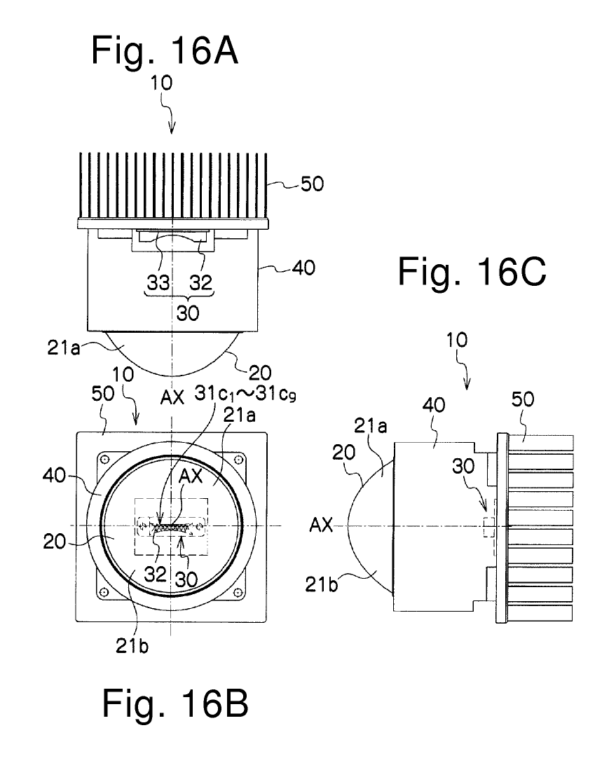

FIG. 17A is a vertical cross-sectional view schematically showing the state where the light emitted from the light-emitting device enters a tube portion and light ray Ray2 emitted in a wider angular direction with respect to the optical axis AX is reflected once and exits through each outlet, and FIG. 17B is an enlarged view of the circled portion in FIG. 17A;

FIG. 18A is a horizontal cross-sectional view schematically showing the state where the light emitted from the light-emitting device enters the tube portion and light ray Ray2 emitted in a wider angular direction with respect to the optical axis AX is reflected once and exits through each outlet, and FIG. 18B is an enlarged view of the circled portion in FIG. 18A;

FIG. 19A is a front view of the projection lens, FIG. 19B is a cross-sectional view of the projection lens of the lighting unit of FIG. 14 taken along line 0-0, FIG. 19C is a cross-sectional view of the projection lens taken along line 30-30, FIG. 19D is a cross-sectional view of the projection lens taken along line 60-60, and FIG. 19E is a cross-sectional view of the projection lens taken along line 90-90;

FIG. 20A is an enlarged view of the circled portion in FIG. 19B, FIG. 20B is an enlarged view of the circled portion in FIG. 19C, and FIG. 20C is an enlarged view of the circled portion in FIG. 19D;

FIG. 21A is a cross-sectional view of the lighting unit of FIG. 14 taken along line 0-0, and FIG. 21B is an enlarged view of the circled portion in FIG. 21A;

FIG. 22A is a cross-sectional view of the lighting unit of FIG. 14 taken along line 30-30, and FIG. 22B is an enlarged view of the circled portion in FIG. 22A;

FIG. 23A is a cross-sectional view of the lighting unit of FIG. 14 taken along line 60-60, and FIG. 23B is an enlarged view of the circled portion in FIG. 23A;

FIG. 24A is a view showing the light distribution pattern formed based on the light source image projected by a projection lens that has a standard lens surface assumed to be the entire surface (images of respective outlets as the light sources), and FIG. 24B is a view showing the light distribution pattern formed based on the light source image projected by the projection lens including the standard lens surface and a gradually varied lens surface (images of respective outlets as the light sources); and

FIG. 25 is a front view of the projection lens of FIG. 14.

### DESCRIPTION OF EXEMPLARY EMBODIMENTS

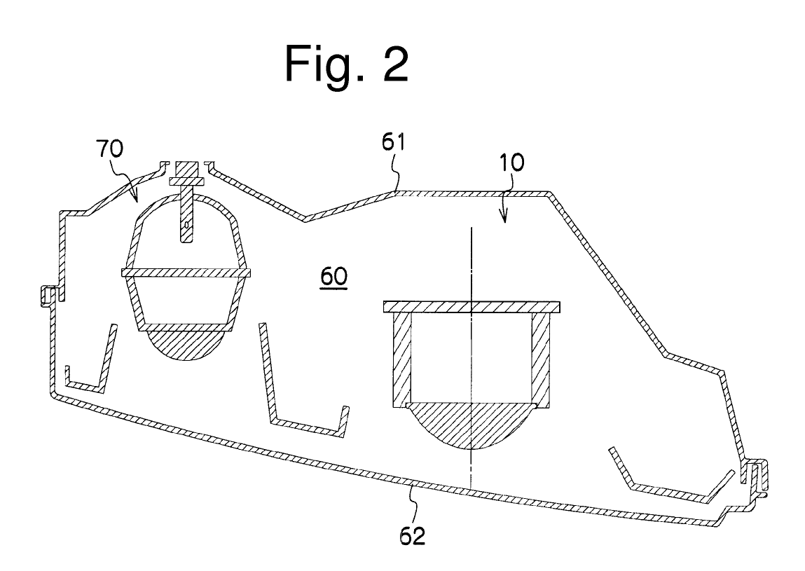

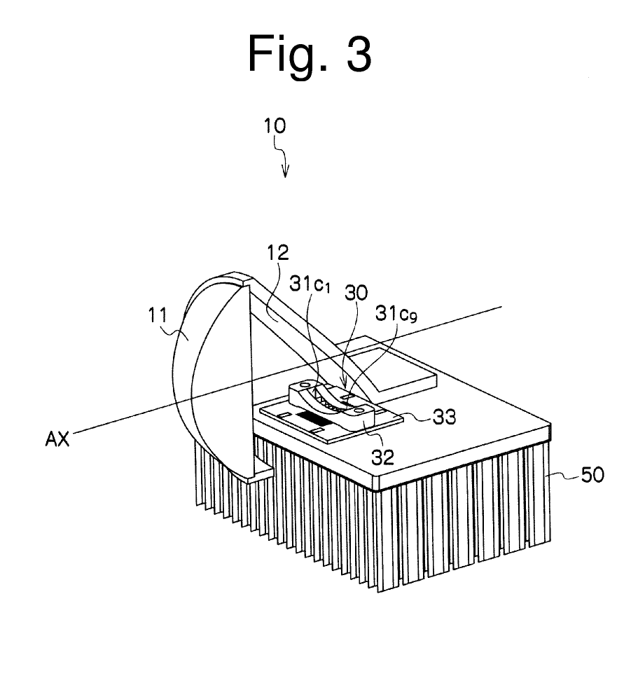

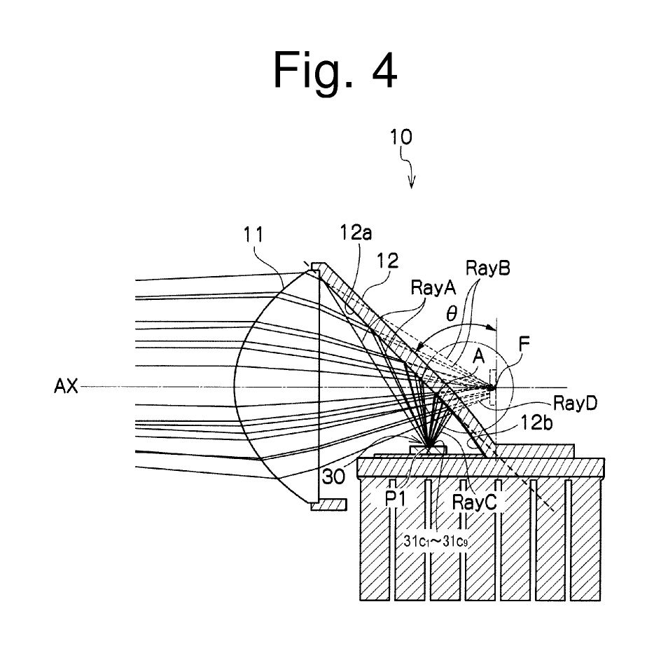

A description will now be made below to lighting units of the presently disclosed subject matter with reference to the accompanying drawings in accordance with exemplary embodiments. Note that the upper, lower, left, right, front and rear directions may be defined on the basis of the vehicle body on which the lighting unit is mounted otherwise specifically limited. The lighting unit 10 of one exemplary embodiment can be a projector type lighting unit and installed on a front portion of a vehicle body at right and left sides to constitute a vehicle headlamp. Specifically, the lighting unit 10 can be combined with another lighting unit 70 dedicated to generate a low beam and housed in a lighting chamber 60 (which is composed of a housing 61 and a translucent cover 62) as shown in FIG. 2, thereby constituting a vehicle headlamp. As shown in FIGS. 3 and 4, the lighting unit 10 can include a projection lens 11 having an optical axis AX and a rear-side focal point F positioned on the optical axis AX, a reflector disposed between the projection lens 11 and the rear-side focal point F, and a light source unit 30 disposed below the reflector 12. The projection lens 11 can be a plano-convex aspheric lens having a convex front surface and a planar rear surface, for example. The projection lens 11 can project the light source image on a plane including its rear-side focal point F to form an inverted image. The projection lens 11 can be fixed at the front end portion of the reflector 12, as shown in FIG. 3.

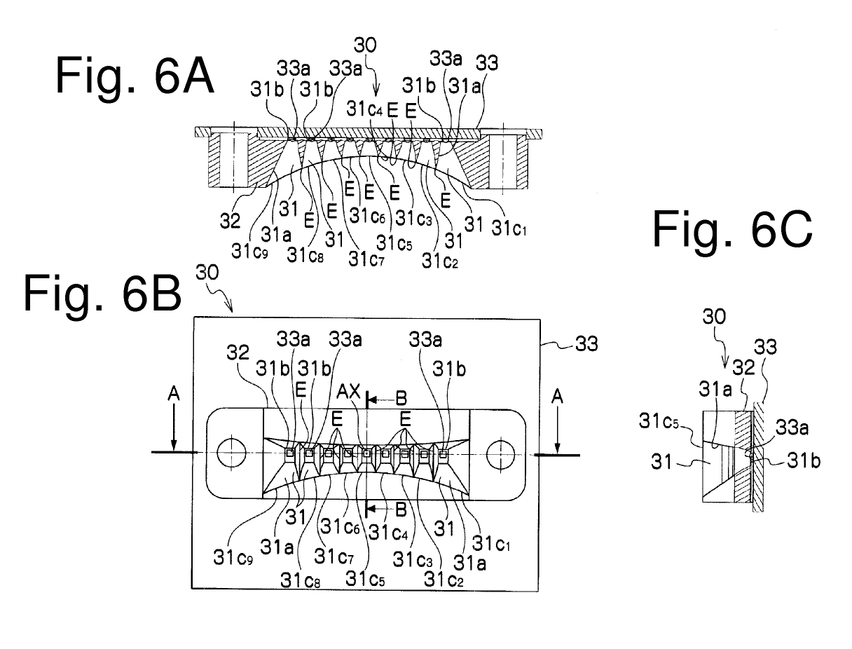

As shown in FIG. 4, the reflector serving as a light path adjusting unit can include a planar minor 12a disposed between the projection lens 11 and the rear-side focal point F of the projection lens 11 and inclined by about 45 degrees (θ) toward the projection lens 11 with respect to the plane perpendicular to the optical axis AX of the projection lens 11. The reflector 12 can include a reflection area 12b concavely curved with respect to the light source unit 30 to diffuse an upper portion of the image of the light source (images of respective outlets 31_{c1} to 31_{c9} as the light sources as shown in FIG. 6) to be projected by the projection lens 11 upward. In FIG. 4, the range from the upper end of the reflector 12 to the inflection point A can serve as the planar minor 12a while the range from the inflection point A to the lower end of the reflector 12 can serve as the reflection area 12b. The inflection point A in FIG. 4 can be positioned below the optical axis AX, but may be positioned above the optical axis AX due to the size of the projection lens 11, the size of the light source unit 30, and other factors. The curved reflection region 12b can have a region that can be formed gradually concave from the inflection point to the lower end of the reflector 12, or alternatively, the longitudinal cross-section (cross-section appearing in FIG. 4) may be an arc with a constant curvature. FIGS. 6A to 6C show a light source unit 30. The light source unit 30 can include a plurality of light-emitting devices 33a disposed in line and a plurality of tube portions 31 (tubular openings) disposed in front of the plurality of light-emitting devices 33a. The light emitted from each light-emitting device 33a can enter through the inlet 31b of the corresponding tube portion 31 and be reflected by the inner peripheral surface (reflector 31a) of the tube portion 31 to exit from the other end of the tube portion 31 or each outlet 31_{c1} to 31_{c9}. With this configuration, a uniform luminance distribution (or a particular luminance distribution) can be formed over the respective outlets 31_{c1} to 31_{c9}. As shown in FIG. 4, the light source unit 30 can be disposed at or near a position P1 symmetrical to the rear-side focal point F of the projection lens 11 with respect to the planar minor 12a as a symmetric plane so as to emit upward light (namely, the outlets 31_{c1} to 31_{c9} are directed upward).

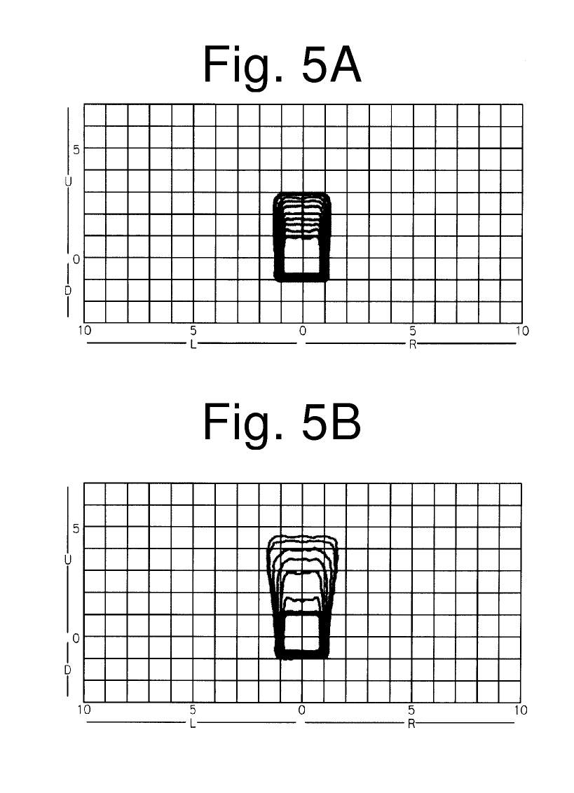

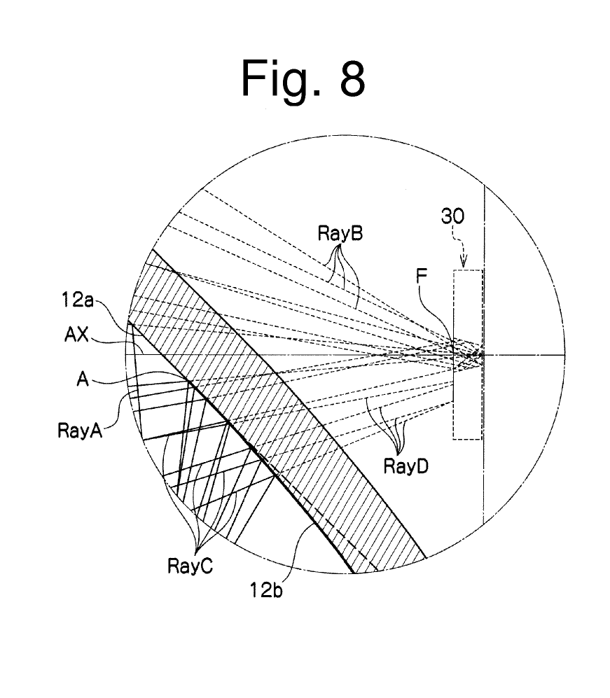

A description will be given of light paths of light rays emitted from the light source unit 30 (from the outlets 31_{c1} to 31_{c9}). As clearly seen from FIG. 4, the light path RayA of the light reflected by the planar minor 12a can be substantially the same as the light path RayB of the light emitted from the light source unit 30 disposed at or near the rear-side focal point F of the projection lens 11 (which is a minor image with respect to the planar minor 12a serving as a symmetric plane) (see the light paths shown by dotted lines in FIG. 4 and FIG. 8). In this case, the light distribution pattern formed by the light source image (images of respective outlets 31_{c1} to 31_{c9} as the light sources) that is reflected by the planar mirror 12a and projected by the projection lens 11 can range between the upper degree of about 3° above the horizontal line and the lower angle of about 1° as shown in FIG. 5A. With this configuration, the area where an overhead sign and the like are provided (simply referred to as an “overhead sign area”) cannot be illuminated with this light distribution pattern. Note that the overhead sign area can be an area on a virtual vertical screen set in front of the vehicle body (for example, 25 m away from the vehicle body) and above the horizontal line, and include road signs and the like to be recognized by a driver during travelling, and the area may range from the upper angle of about 2° to 4°. On the other hand, the light path RayC of the light reflected by the curved reflection area 12a can be substantially the same as the light path RayD of the light emitted from the lower portion of the light source unit 30 disposed at or near the rear-side focal point F of the projection lens 11 (which is a mirror image with respect to the planar minor 12a serving as a symmetric plane) (see the light paths shown by dotted lines in FIG. 4 and FIG. 8). In this case, the upper portion of the light source image (images of respective outlets 31_{c1} to 31_{c9} as the light sources) reflected by the curved reflection area 12b and projected by the projection lens 11 can be diffused and directed upward. Accordingly, the light distribution pattern formed together with the diffused upper portion of the light source image can range between the upper degree of about 4.5° and the lower angle of about 1° as shown in FIG. 5B. This light source image including the diffused upper portion can illuminate the overhead sign area.

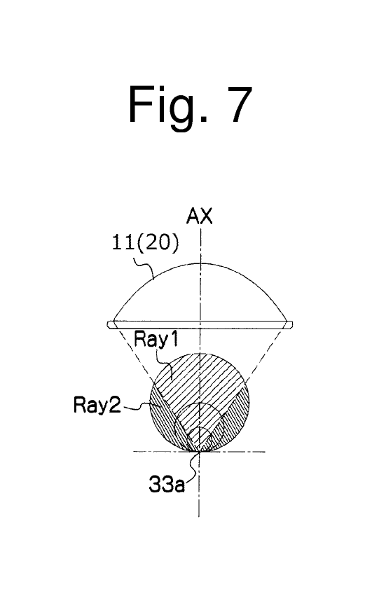

In the lighting unit 10 with the above configuration, the light (images of respective outlets 31_{c1} to 31₉ as the light sources) emitted upward from the light source unit 30 (respective outlets 31_{c1} to 31_{c9}) can be reflected by the reflector 12 (the planar minor 12a and the curved reflection area 12b) and projected through the projection lens 11 forward. In this manner, the longitudinally long light distribution pattern vertically enlarged (ranging from the upper degree of about 4.5° to the lower degree of about 1° with respect to the horizontal line) can be formed on the virtual vertical screen disposed in front of a vehicle body (see FIG. 5b). With this longitudinally long light distribution pattern, a travelling beam irradiation area (a high luminance area so-called “hot zone” including a crossing point between the horizontal line H and the vertical line V) and an overhead sign area can be illuminated. Next, a description will be given of the light source unit 30. As shown FIGS. 6A to 6C, the light source unit 30 can include the plurality of light-emitting devices 33a disposed in line and the plurality of tube portions 31 (tubular openings) disposed in front of the plurality of light-emitting devices 33a, which constitute a light guiding member 32. The plurality of light-emitting devices 33a can be disposed in line on a metal substrate 33 fixed on a heat sink 50 (see FIG. 3) at constant intervals (about 2 mm) in a horizontal direction perpendicular to the optical axis AX. A white LED having a 0.7-mm square light-emission surface can be used as the light-emitting device 33a. Other examples of the light-emitting device 33a may include other light-emitting diodes, and laser diodes. Examples of the white LED may include a white LED including a blue LED chip and a phosphor in combination, a white LED including a near-ultraviolet LED chip and a phosphor in combination, and a white LED including R, G and B LED chips in combination. As shown in FIG. 7, the light radially emitted from the light-emitting device 33a may include light rays Ray1 in a narrow angular direction and light rays Ray2 in a wider angular direction with respect to the optical axis AX (it should be noted that in the drawing the state assumed so that the light rays reflected by the reflector 12 are shown in a linear optical path, and the optical axis AX is shown in the same manner). In order to cause the light rays Ray2 in the wider angular direction with respect to the optical axis AX to enter the projection lens 11, the light guiding member 32 configured to control the light rays Ray2 in the wider angular direction can be disposed in front of the respective light-emitting device 33a (see FIGS. 3 and 6A). As shown in FIGS. 6A to 6C, the light guiding member 32 can include the plurality of tube portions 31 (tubular openings) that can communicate the one side and the opposite side. On the inner peripheral surface of each tube portion 31, a reflector 31a can be formed by subjecting it to minor finishing (such as aluminum deposition). The light guiding member 32 can be formed by integrally injection molding a heat-resistant plastic material into the plurality of integrated tube portions 31.

The light guiding member 32 can be positioned with respect to the substrate 33 so that the one ends or inlets 31b of the tube portions 31 are disposed in front of the corresponding light-emitting devices 33a and the other ends or outlets 31_{c1} to 31_{c9} of the tube portions 31, and then be screwed or otherwise attached to the upper surface of the heat sink 50 with the substrate 33 interposed therebetween. The respective inlets 31b can be disposed below the position P1 symmetrical to the rear-side focal point F of the projection lens 11 with respect to the symmetrical surface of the planar mirror 12a by about 2.0 mm (or disposed farther from the position P1). The inlets 31b each can be sized to be slightly wider than the light-emitting device 33a (for example, 1 mm width in the horizontal direction and 1.5 mm in the vertical direction). The respective outlets 31_{c1} to 31_{c9} can be disposed at or near the position P1 symmetrical to the rear-side focal point F of the projection lens 11 with respect to the symmetrical surface of the planar mirror 12a (for example, along the area plane symmetrical to the rear-side focal point plane of the projection lens 11), and also be disposed side by side in line in a horizontal direction and a direction perpendicular to the optical axis AX (see FIGS. 3 and 4). The shape of the outlets 31_{c1} to 31_{c9} can be a square, parallelogram, trapezium, and the like.

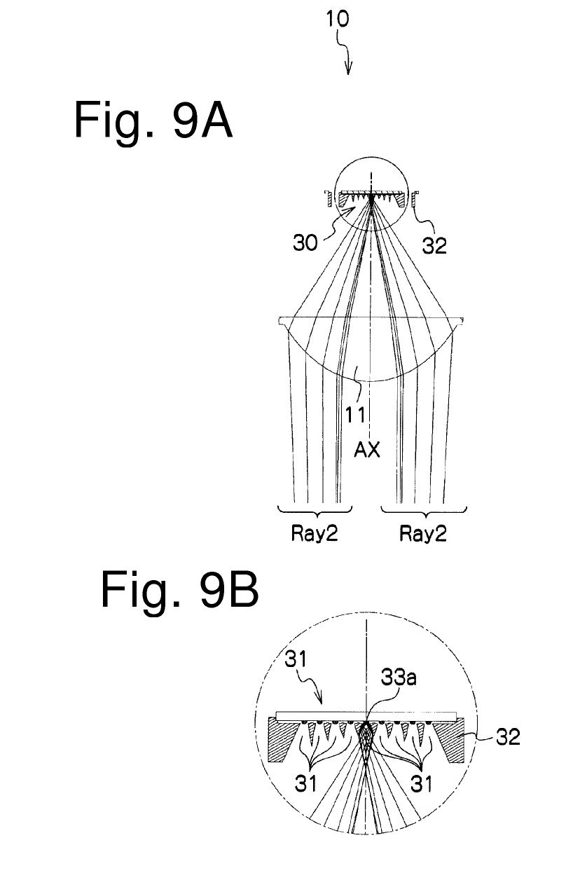

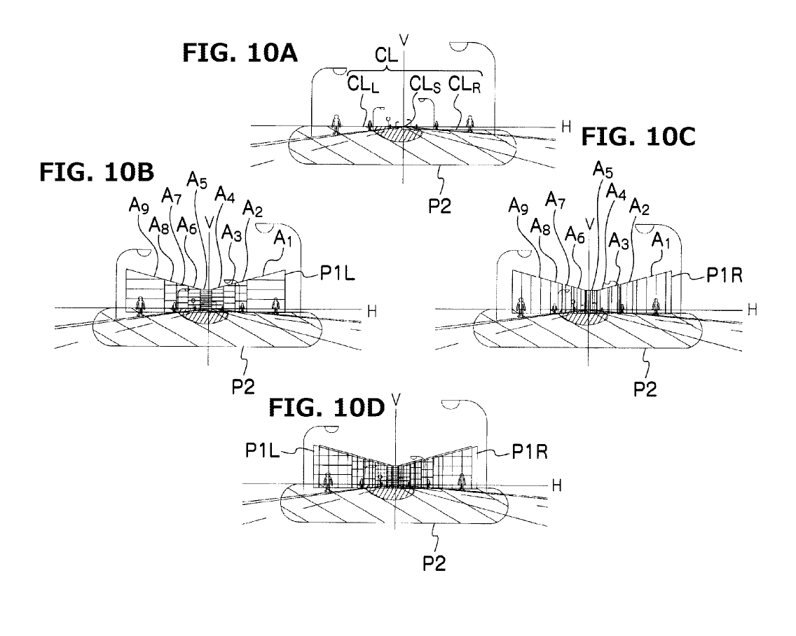

The light (images of respective outlets 31_{c1} to 31_{c9} as the light sources) emitted upward from the light source unit 30 (respective outlets 31_{c1} to 31_{c9}) can be reflected by the reflector 12 and projected through the projection lens 11 forward (see FIG. 4). In this manner, the light distribution patterns P1L and P1R including a plurality of irradiated areas A₁ to A₉ arranged side by side in the horizontal direction can be formed on the virtual vertical screen (see FIGS. 10B and 10C). In this case, the plurality of irradiated areas A₁ to A₉ can be individually controlled in light intensity. Note that in this exemplary embodiment the outlets 31_{c1} to 31_{c9} can be set to gradually increase in size from the optical axis AX to the farther position (see FIG. 6B). For example, the vertical width can range from 3 mm to 6 mm, the horizontal width of the outlets 31_{c2} to 31_{c8} can be 2 mm, and the horizontal width of the outlets 31_{c1} and 31_{c9} can be 4.5 mm. At this time, if a thick portion exists in between the outlets 31_{c1} to 31_{c9}, the image of the thick portion may be projected forward, thereby resulting in the generation of a gap between the irradiated areas A₁ to A₉. To prevent this, adjacent outlets (for example, the outlets 31_{c1} and 31_{c2}) among the outlets 31_{c1} to 31_{c9} of the plurality of tube portions 31 can include a common edge wall E that partitions the outlets 31_{c1} to 31_{c9} with almost negligible width. Namely, the outlets 31_{c1} to 31_{c9} can be surrounded by the edge walls E. With this configuration, the plurality of irradiated areas A₁ to A₉ that are inverted projected images of the outlets 31_{c1} to 31_{c9} can be arranged side by side in the horizontal direction without gap therebetween (see FIGS. 10B and 10C). FIGS. 9A and 9B show light paths of light emitted from the light source unit 30 disposed at or near the position plane-symmetrical to the rear-side focal point F of the projection lens 11 (minor image with respect to the planar mirror 12a as the symmetric plane). As shown in FIGS. 6A, 9A and 9B, the light emitted from the light-emitting device 33a (light rays Ray2 emitted in a wider angular direction with respect to the optical axis AX) can enter the plurality of tube portions 31 and be reflected once and exit through each outlet 31_{c1} to 31_{c9}. In order to achieve this, the plurality of tube portions 31 (reflectors 31a) can be configured to be a pyramidal shape narrowed from the outlets 31_{c1} to 31_{c9} to the inlet 31b. The action of the tube portions 31 (reflectors 31a) can cause not only the light rays Ray1 in a narrower angular direction with respect to the optical axis AX but also light rays Ray2 in a wider angular direction with respect to the optical axis AX to enter the projection lens 11. Accordingly, the light utilization efficiency can be improved (see FIGS. 9A and 9B).

Note that the plurality of tube portions 31 can be a pyramidal shape narrowed from the outlets 31_{c1} to 31_{c9} to the inlet 31b, and the adjacent outlets (for example, outlets 31_{c1} and 31_{c2}) can include a common edge wall E that partitions the outlets 31_{c1} to 31_{c9} with almost negligible width, but there is no specific limitation as to the shape, degree of expansion, and the like of the edge wall E and the like. In the present exemplary embodiment, the respective reflectors 31a of the tube portions 31 can be optimized so as to reflect the light from the light-emitting devices 33a once and form a uniform luminance distribution (or a particular luminance distribution) over the respective outlets 31_{c1} to 31_{c9} to be incident on the projection lens 11. The end edges (upper end edge in FIG. 6B) of the respective outlets 31_{c1} to 31_{c9} corresponding to the lower end edges of the light source images (images of respective outlets 31_{c1} to 31_{c9} as the light sources) can extend in a horizontal direction when viewed from front side. The portion of the end edges can be reflected by the reflector 12 and projected by the projection lens 11 to thereby overlay the lower end edges of the light source image (images of respective outlets 31_{c1} to 31_{c9} as the light sources) to the horizontal cut-off line of the low beam light distribution pattern P2.

The center of the outlets 31_{c1} to 31_{c9} in the optical axis direction AX (that can pass through the position P1 plane-symmetrical to the rear-side focal point F and in the vertical direction with respect to the paper surface of the drawing) may be disposed slightly lower (farther from the position P1 corresponding to the rear-focal point F of the projection lens 11), and specifically by about 1.0 mm. With this configuration, the luminous intensity of the upper end edge and vicinities thereof of the outlets 31_{c1} to 31_{c9} can be improved. Namely, the plurality of irradiated areas A₁ to A₉ that are arranged side by side in the horizontal direction can be enhanced in luminous intensity near their lower end edges. Accordingly, it is possible to form light distribution patterns P1L and P1R that are superior in farther side visibility or brighter in the vicinity of the horizontal line H-H. On the other hand, the end edges of the outlets 31_{c1} to 31_{c9} corresponding to the upper end edge of the light source image (images of respective outlets 31_{c1} to 31_{c9} as the light sources) can extend in an arc shape when viewed from front in FIG. 6B (lower end edge in FIG. 6B) in order to allow the height of the plurality of irradiated areas A₁ to A₉ on the virtual vertical screen to be small at a farther position and gradually be enlarged at a nearer position. In this manner, the farther position can be a high luminous flux density and the nearer area can be illuminated in a wider range. Next, a description will be given of the light distribution patterns P1L and P1R formed by the lighting unit 10 with the above configuration. The lighting units 10 installed on both the right and left sides of the vehicle body can have the same configuration, and form the light distribution patterns P1L and P1R including the plurality of irradiated areas A₁ to A₉ that can be individually controlled in light intensity. The lighting units 10 on both the right and left sides of the vehicle body can be aimed such that the plurality of irradiated areas A₁ to A₉ are partially overlaid with each other (for example, shifted by 1 degree in the horizontal direction) (see FIG. 10D). By turning off or supplying with reduced power the particular light-emitting device 33a, two sets of the irradiated areas A₁ to A₉ (18 in total) can be controlled in luminous intensity. Note that near the center the luminous intensity control can be achieved by an interval of 1 degree.

The light rays Ray1 in a narrower angular direction with respect to the optical axis AX cannot be reflected by the reflector 31a of the tube portion 31 and directly exit through the outlets 31_{c1} to 31_{c9} to be reflected by the reflector 12 and enter the projection lens 11. On the other hand, the light rays Ray2 in a wider angular direction with respect to the optical axis AX can be reflected by the reflector 31a of the tube portion 31 once and exit through the outlets 31_{c1} to 31_{c9} to be reflected by the reflector 12 and enter the projection lens 11. (See FIGS. 9A and 9B.) This direct light rays Ray1 and the reflected-once light rays Ray2 can form a uniform luminance distribution (or a particular luminance distribution) over the respective outlets 31_{c1} to 31_{c9}. The images of respective outlets 31_{c1} to 31_{c9} (the luminance distribution formed over the outlets 31_{c1} to 31_{c9}) can be inverted and projected through the projection lens 11 forward. In this manner, the light distribution patterns P1L and P1R including the plurality of irradiated areas A₁ to A₉ having clear contours and arranged side by side in the horizontal direction can be formed on the virtual vertical screen (see FIGS. 10B and 10C). In this case, the plurality of irradiated areas A₁ to A₉ can be individually controlled in light intensity. Note that on the virtual vertical screen the 1-mm square shape on the rear-side focal point plane of the projection lens 11 can be observed as an image sized 1 degree range. The center of the outlets 31_{c1} to 31_{c9} in the optical axis direction AX (that can pass through the position P1 plane-symmetrical to the rear-side focal point F and in the vertical direction with respect to the paper surface of the drawing) may be disposed slightly lower (farther from the position P1 corresponding to the rear-focal point F of the projection lens 11), and specifically by about 1.0 mm. Accordingly, the plurality of irradiated areas A₁ to A₉ can be disposed on the virtual vertical screen upward by about 1 degree with respect to the horizontal line H-H. On the other hand the plurality of irradiated areas A₁ to A₉ can be formed in the horizontal direction as follows. Specifically, the outlets 31_{c2} to 31_{c8} each have the rectangular shape with a vertical width of 3 mm and a horizontal width of 2 mm, and the center thereof can be disposed on a vertical plane with respect to the optical axis AX. Accordingly, the irradiated areas A₂ to A₈ corresponding to the outlets 31_{c2} to 31_{c8} can each have a square area disposed on the V-V line at its center with a vertical width of 3 degrees and a horizontal width of 2 degrees. Then, the outlets 31_{c1} and 31_{c9} each have the rectangular shape with a vertical width of 3 mm and a horizontal width of 4.5 mm, and disposed outside of the outlets 31_{c2} to 31_{c8}. Accordingly, the irradiated areas A₁ and A₉ corresponding to the outlets 31_{c1} and 31_{c9} can each have a square area disposed outside of the irradiated areas A₂ and A₈ with a vertical width of 3 degrees and a horizontal width of 4.5 degrees. Next, a description will be given of the low beam light distribution pattern P2 formed by the lighting unit 70 dedicated to form the low beam (see FIG. 2). As shown in FIG. 10A, the low beam light distribution pattern P2 can be a left side light distribution pattern and have a cut-off line CL with the stepped upper end edge. The cut-off line CL can extend in the horizontal direction and has a stepped portion at the V-V line passing through the H-V vanishing point and vertically extending. The line on the right side of the V-V line can be formed as a cut-off line CLR on the opposed lane side. The line on the left side of the V-V line can be formed as a cut-off line CLL on the present vehicle lane that extends in the horizontal line at a higher level than the cut-off line CLR. Between these cut-off lines CLR and CLL, an inclined cut-off line CLS can be formed near the V-V line as an extension of the CLL and inclined by 15 degrees.

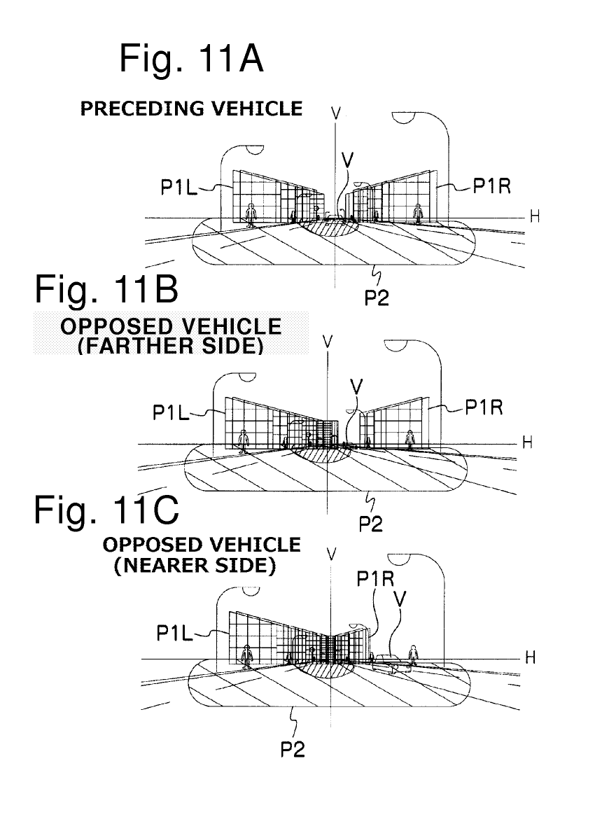

In the low beam light distribution pattern P2, the elbow point E being the crossing point between the cut-off line CLR and the V-V line can be disposed below H-V by 0.5 to 0.6 degrees. A hot zone being a high luminance area can be formed to surround the elbow point E from left side. Note that the above light distribution patterns P1L, P1R, and P2 are overlaid with each other to form a synthesized light distribution pattern as shown in FIG. 10D. Next, a description will be given of an example of individually turning off, or supplying with reduced power, the plurality of light-emitting device 33a (the plurality of irradiated areas A₁ to A₉). For example, as shown in FIG. 11A, if a preceding vehicle V is positioned farther in front of the vehicle body (or an opposite vehicle V is positioned farther in front of the vehicle body as shown in FIG. 11B), the lighting unit 10 can be controlled such that the light-emitting devices 33a corresponding to the irradiated areas that are among the plurality of the irradiated areas A₁ to A₉ and covering the area where the vehicle V is positioned can be turned off or reduced in luminous intensity. In this manner, the glare light against the preceding vehicle V or opposite vehicle V can be prevented. In addition, the visibility on a road surface in front of the vehicle body can be improved.

As shown in FIG. 11, if the opposite vehicle V is positioned close to the driven vehicle, the lighting unit 10 can be controlled such that the light-emitting devices 33a corresponding to the irradiated areas that are among the plurality of the irradiated areas A₁ to A₉ and covering the area where the opposite vehicle V is positioned can be turned off or reduced in luminous intensity. In this manner, the glare light against the opposite vehicle V close to the driven vehicle can be prevented. In addition, the visibility on a road surface in front of the vehicle body can be improved.

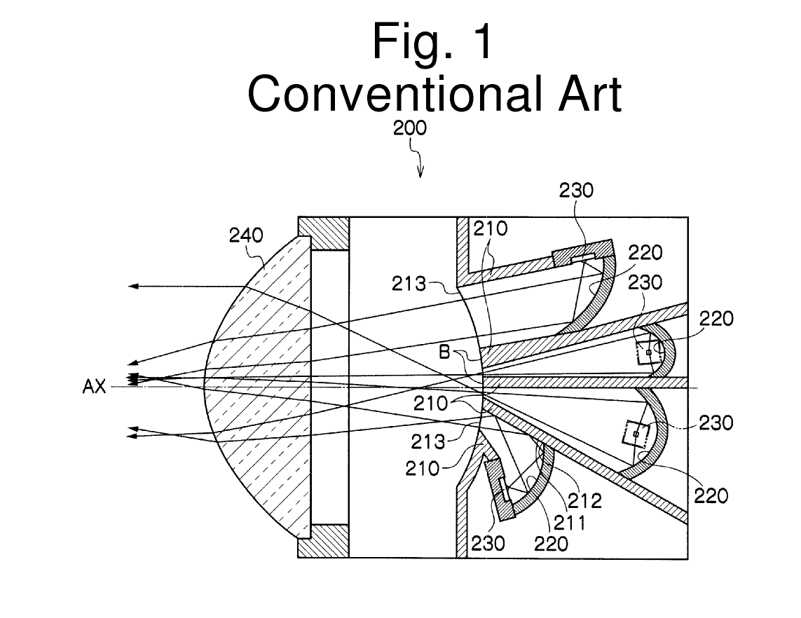

The position of a preceding vehicle or an opposite vehicle in the horizontal direction on the virtual vertical screen can be carried out in the following method. Specifically, the surrounding areas and objects can be shot by a car-mounted CCD camera or the like to detect the position of, for example, a headlamp (or tail lamp) of the vehicle close to the driven vehicle, thereby detecting the position of the vehicle close to the driven vehicle. As described above, the upper portion of the light source image (images of respective outlets 31_{c1} to 31_{c9} as the light sources) reflected by the curved reflection area 12b and projected by the projection lens 11 can be diffused and directed upward. Accordingly, the longitudinally long light distribution pattern (vertically expanded) can be formed on the virtual vertical screen without deteriorating the light utilization efficiency (see FIG. 5B). In the present exemplary embodiment, the partition between the adjacent outlets (for example, the outlets 31_{c1} and 31_{c2}) among the outlets 31_{c1} to 31_{c9} of the plurality of tube portions 31 is not formed of a thick wall portion (the thick wall portion B in FIG. 1), but an edge wall E with almost negligible width. Accordingly, the plurality of outlets 31_{c1} to 31_{c9} partitioned by the thin edge wall E (or luminance distribution formed by the outlets 31_{c1} to 31_{c9}) can be inverted and projected forward by the action of the projection lens 11 (see FIG. 6B). The use of a single lighting unit 10 can prevent or lower the gap (or darkened area) between the plurality of the irradiated areas A₁ to A₉ that can be adjusted by individually controlling the light-emitting devices. In contrast to this, the conventional lighting device uses another lighting unit for irradiating the gap (or darkened area) between the plurality of the irradiated areas. Accordingly, the presently disclosed subject matter does not need such an additional lighting unit separately. In the present exemplary embodiment, the plurality of light-emitting devices 33a can be arranged in line in the horizontal direction while the light-emission surface is virtually directed forward (see FIG. 4). Accordingly, when compared with the case where a plurality of light—emitting devices are dispersedly arranged in the optical axis AX (see the plurality of light-emitting devices 230 in FIG. 1), a lighting unit with a shorter size in the optical axis AX direction can be configured. In the present exemplary embodiment, the light emitted from the light-emitting device 33a (light rays Ray2 emitted in a wider angular direction with respect to the optical axis AX) can enter the plurality of tube portions 31 and be reflected once and exit through each outlet 31_{c1} to 31_{c9}. Further, the plurality of tube portions 31 (reflectors 31a) can be configured to be a pyramidal shape narrowed from the outlets 31 to the inlet 31b (see FIG. 6B). The action of the tube portions 31 (reflectors 31a) can cause not only the light rays Ray1 in a narrower angular direction with respect to the optical axis AX but also light rays Ray2 in a wider angular direction with respect to the optical axis AX to enter the projection lens 11. Accordingly, the light utilization efficiency can be improved. In the present exemplary embodiment, the lighting units can be composed of less number of parts because a plurality of reflectors are not used (when compared with the case where a plurality of reflectors 220 are used as shown in FIG. 1). In the present exemplary embodiment, a plurality of light-emitting devices 33a can be mounted on the same substrate 33. Accordingly, the plurality of light-emitting devices 33a can be united and easily assembled when compared with the case where a plurality of light emitting devices are not mounted on the same substrate but dispersedly arranged in the optical axis AX direction (a plurality of reflectors 220 are used as shown in FIG. 1). In addition, the positioning of the plurality of light-emitting devices 33a to the plurality of tube portions 31 can be performed with higher accuracy. In the present exemplary embodiment, the images of the plurality of light-emitting devices 33a are not directly projected but light images appearing at the outlets 31_{c1} to 31_{c9} of the light guide member 32 are inverted and projected. Accordingly, when compared with the configuration where the images of the plurality of light-emitting devices 33a are directly projected, the distance between the plurality of light-emitting devices 33a can be widened. This configuration can alleviate the adverse effect of heat generated from the light-emitting devices 33a.

In the above exemplary embodiment, the light source unit 30 is disposed below the reflector 12, but the presently disclosed subject matter is not limited thereto. For example, the light source unit 30 can be disposed above the reflector 12 (meaning that the configuration can be reversed upside down). In this case, the inflection point A can be shifted toward the upper edge of the reflector 12 and the reflection area 12b can be assigned to the curved area from the inflection point A to the upper edge. This configuration can provide the same advantageous effects as those of the present exemplary embodiment.

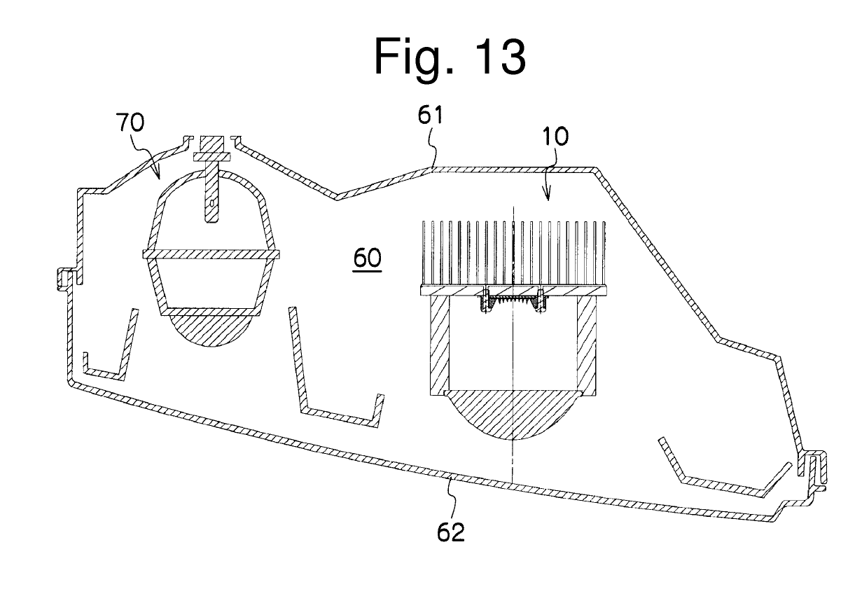

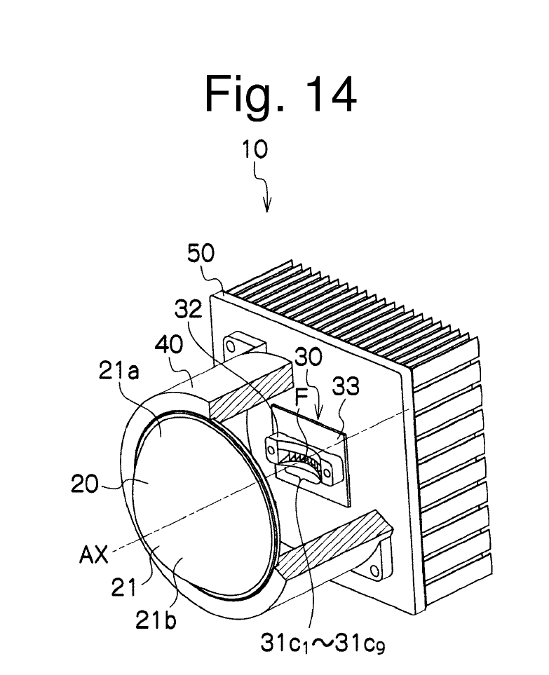

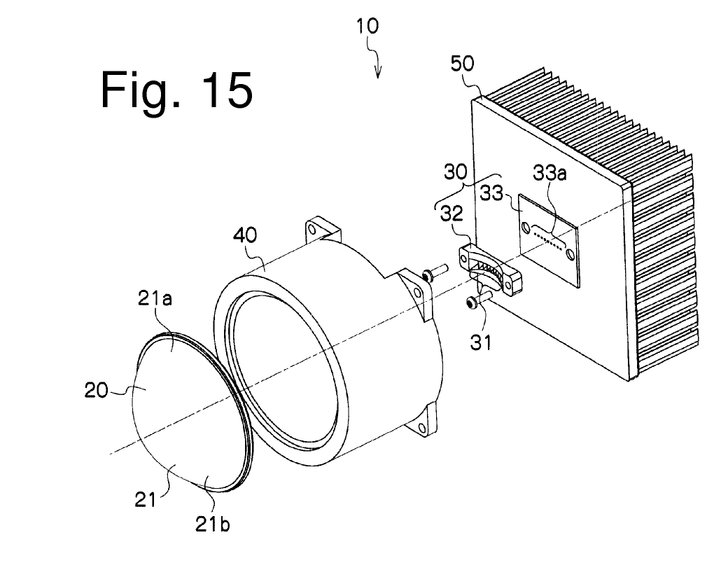

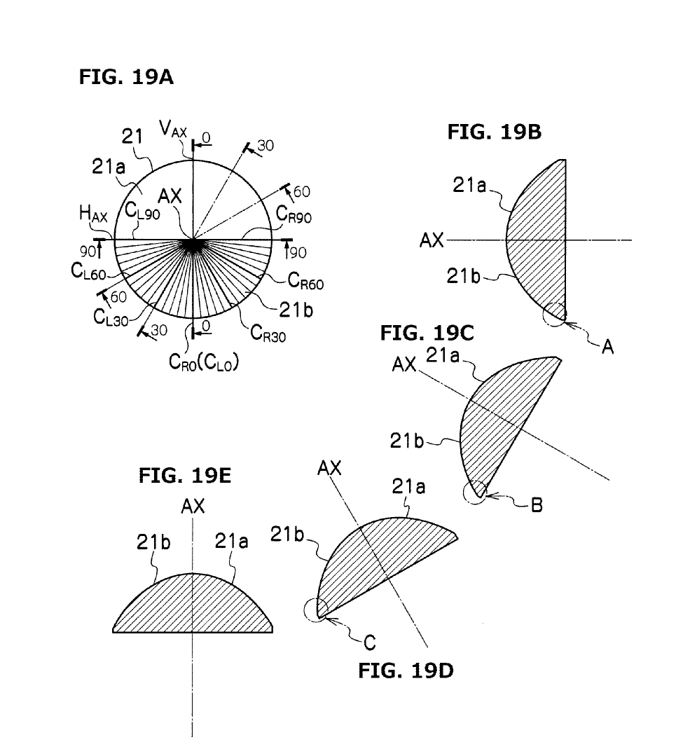

Next, a description will be made below to lighting units of the presently disclosed subject matter with reference to the accompanying drawings in accordance with other exemplary embodiments. The lighting unit 10 of the present exemplary embodiment can be a projector type lighting unit similar to the previous exemplary embodiment and installed on a front portion of a vehicle body at right and left sides to constitute a vehicle headlamp. Specifically, the lighting unit 10 can be combined with another lighting unit 70 dedicated to generate a low beam and housed in a lighting chamber 60 (which is composed of a housing 61 and a translucent cover 62) as shown in FIG. 13, thereby constituting a vehicle headlamp. As shown in FIGS. 14 and 15, the lighting unit 10 can include a projection lens 20 having an optical axis AX and a rear-side focal point F positioned on the optical axis AX, and a light source unit 30 disposed between the projection lens 20 and the rear-side focal point F (or the vicinity thereof). The projection lens 20 can be a plano-convex aspheric lens having a convex front surface as a light exiting surface 21 and a planar rear surface, for example. The projection lens 20 can project the light source image on a plane including its rear-side focal point F to form an inverted image. The projection lens 20 can be held by a lens holding frame 40 or the like and fixed to a heat sink 50 by screwing, for example. As shown in FIG. 19A, the light exiting surface 21 can be a circular or elliptic lens surface when viewed from its front side, and the light path adjusting unit can be configured as the projection lens 20 including a standard lens surface 21a disposed on an upper side of the projection lens 20 with respect to a boarder as a horizontal plane H_{AX} including the optical axis AX of the projection lens 20 and a gradually varied lens surface 21b disposed on a lower side of the projection lens 20. The standard lens surface 21a can be a general aspheric lens surface like in a general projection lens for use in a common projector type headlamp.

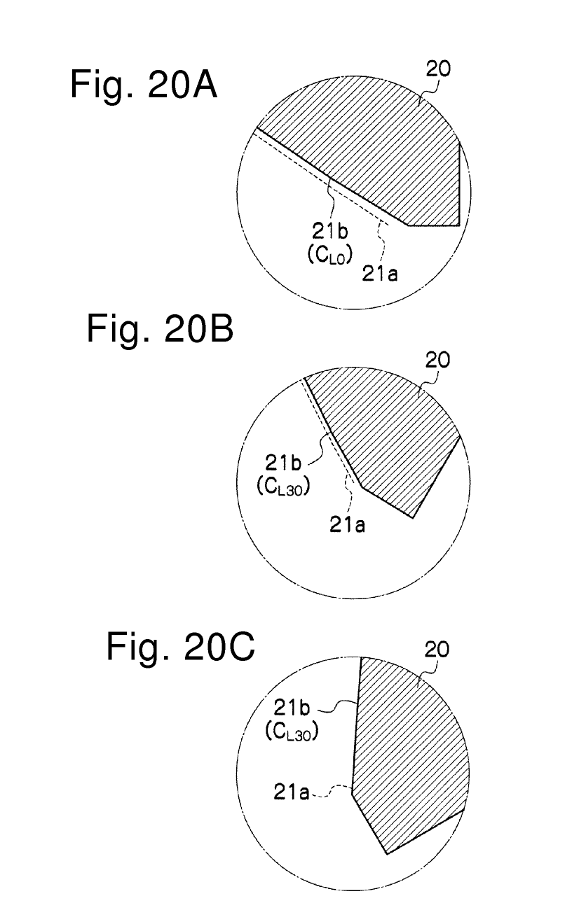

The gradually varied lens surface 21b a lens surface formed from a free curved surface configured such that a plurality of curves C_{L0} to C_{L90} and C_{R0} to C_{R90} appear on crossing lines between a plurality of planes (for example, at angular intervals of 0.5°) and the gradually varied lens surface, the plurality of planes including the optical axis AX of the projection lens 20 and inclined by different inclined angles with respect to a vertical plane V_{AX} including the optical axis AX of the projection lens 20, and the plurality of curves C_{L0} to C_{L90} and C_{R0} to C_{R90} are gradually varied and coupled to each other to form the free curved surface. The plurality of curvatures of the curves C_{L0} to C_{L90} and C_{R0} to C_{R90} can be equal to or lower than a curvature of the standard lens surface 21a as shown in FIGS. 19(b) to 19(e) and 20(a) to 20(c) and can gradually and continuously increase from the vertical plane V_{AX} (C_{L0}, C_{R0}) to the horizontal plane H_{AX} (C_{L90}, C_{R90}). The lens shown in FIGS. 19(b) to (e) is one example of the gradually varied lens surface 21b configured such that the relation of the curvatures is (the curvature of the curved line C_{L0} (C_{R0}) (see FIGS. 19(b) and 20(a))<(the curvature of the curved line C_{L30}(C_{R30}) (see FIGS. 19(c) and 20(b))<(the curvature of the curved line C_{L60} (C_{R60}) (see FIGS. 19(d) and 20(c))<(the curvature of the curved line C_{L90} (C_{R90}) (see FIGS. 19(e))=the curvature of the standard lens surface 21a. For the convenience of description, the plurality of curves C_{L0} to C_{L90} and C_{R0} to C_{R90} appear on the gradually varied lens surface 21b in FIG. 19(a), but in reality, the plurality of curves C_{L0} to C_{L90} and C_{R0} to C_{R90} do not appear on the gradually varied lens surface 21b, but the surface can be a free curved surface with gradually changed curves. The light source unit 30 can be that used in the previous exemplary embodiment and referred to that shown in FIGS. 6A to 6C. Thus, a redundant description thereof is not repeated here.

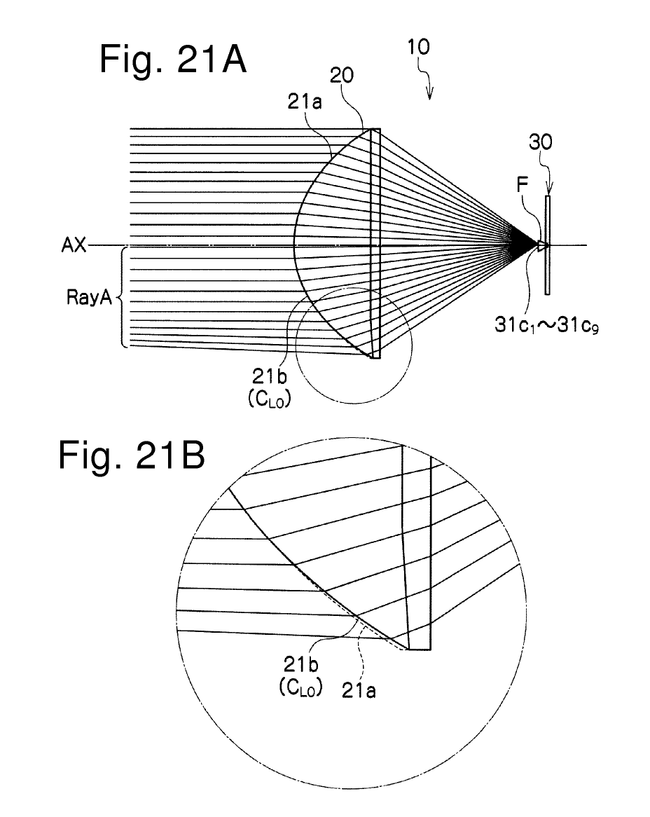

As shown in FIGS. 14 and 21A, the light source unit 30 can be disposed at or near the rear-side focal point F of the projection lens 20 so as to emit light toward the projection lens 20 (namely, the outlets 31_{c1} to 31_{c9} are directed to the projection lens 20).

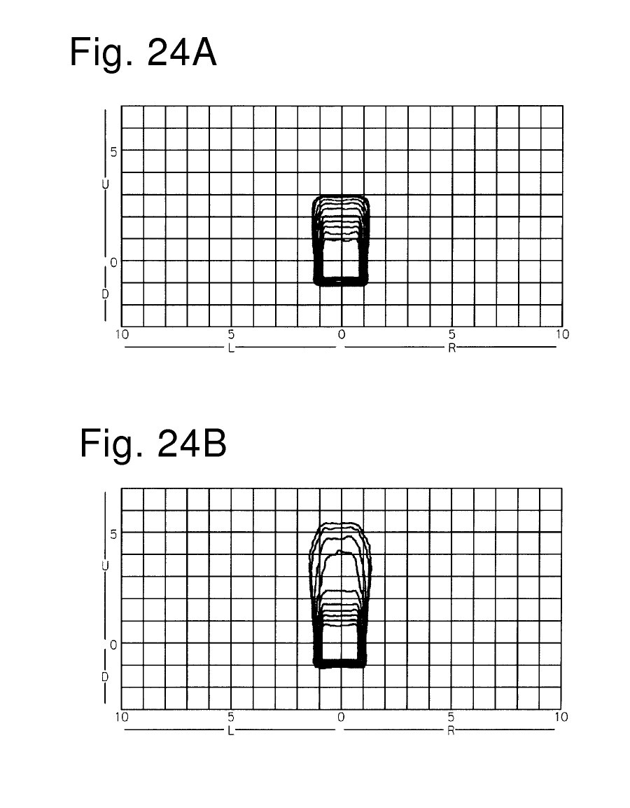

According to the lighting unit 10 with the above configuration as shown in FIG. 21A, the light emitted from the light source unit through the outlets 31_{c1} to 31_{c9} (images of respective outlets 31_{c1} to 31_{c9} as the light sources) can be projected forward through the projection lens 20 (including the standard lens surface 21a and the gradually varied lens surface 21b), thereby forming a light distribution pattern on a virtual vertical screen. If the entire light exiting surface 21 is formed from the standard lens surface, the light distribution pattern as shown in FIG. 24A can be formed on the virtual vertical screen. The light distribution pattern can range between the upper degree of about 3° above the horizontal line and the lower angle of about 1°. With this configuration, the overhead sign area may not be illuminated with this light distribution pattern.

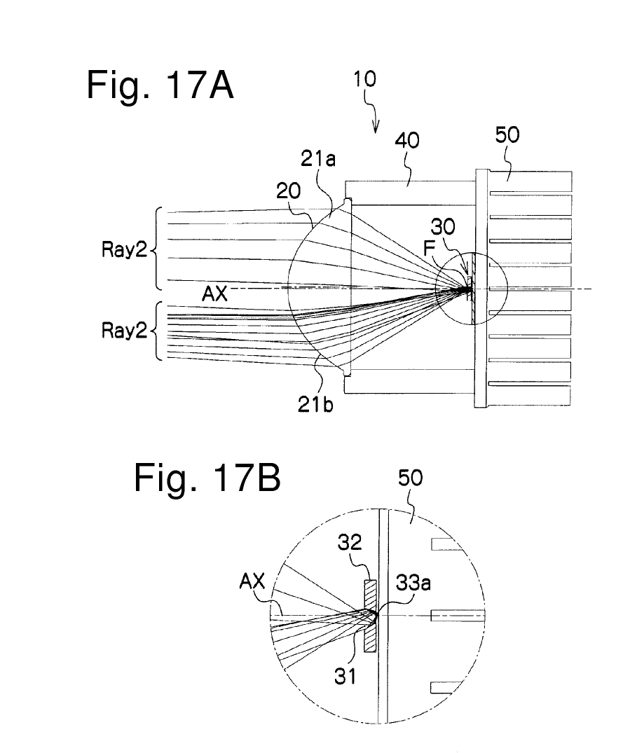

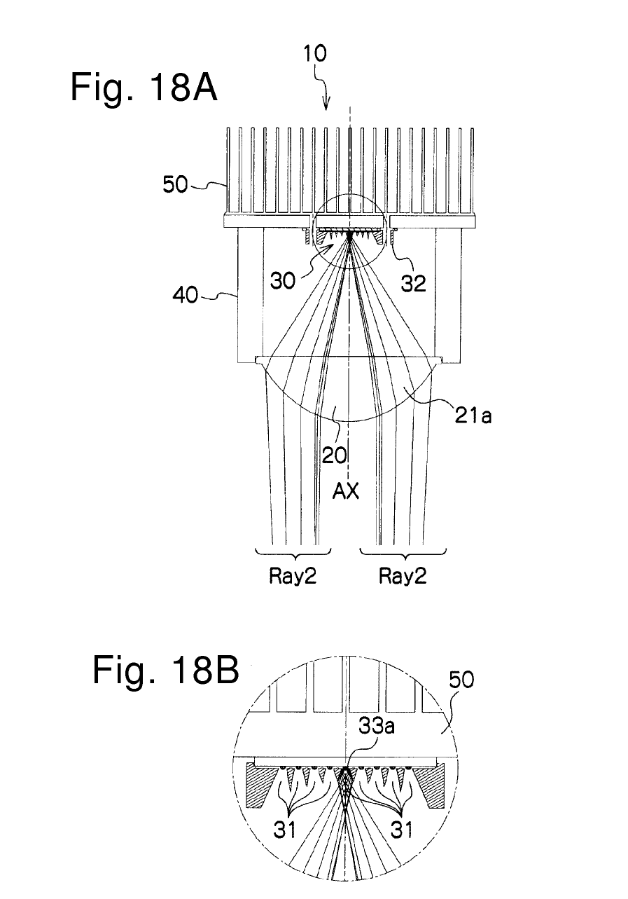

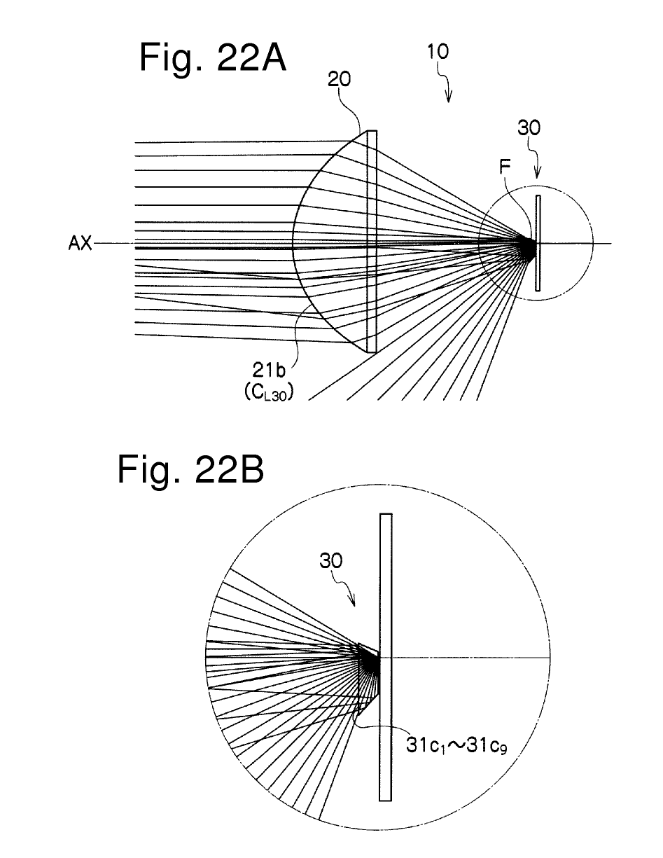

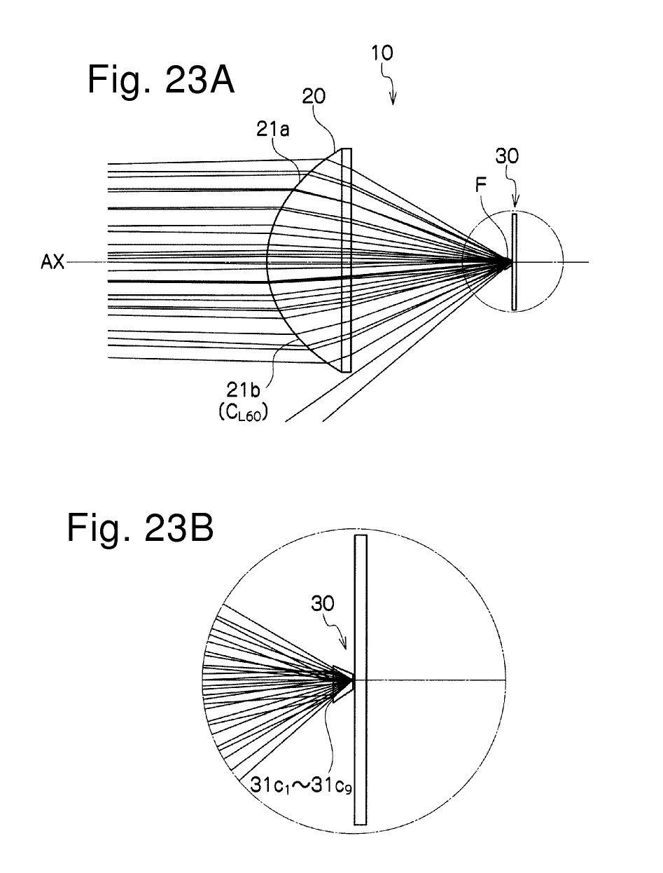

When the light rays RayA projected through the gradually varied lens surface 21b is considered, the light rays RayA can be refracted by the action of the plurality of curves C_{L0} to C_{L90} and C_{R0} to C_{R90} with gradually increasing degree of upward refraction as being closer to the lower side of the lens 20 (see FIGS. 21A to 23B). As a result of this, the longitudinally long light distribution pattern vertically enlarged (ranging from the upper degree of about 4.5° to the lower degree of about 1° with respect to the horizontal line) can be formed on the virtual vertical screen as shown in FIG. 24B with the luminous distribution of the upper portion constantly varied without unevenness. With this longitudinally long light distribution pattern, a travelling beam irradiation area (a high luminance area so-called “hot zone” including a crossing point between the horizontal line H and the vertical line V) and an overhead sign area can be illuminated. It should be noted that the plurality of curvatures of the curves C_{L0} to C_{L90} and C_{R0} to C_{R90} can be determined by a simulation or the like such that the light rays RayA projected through the gradually varied lens surface 21b can illuminate the overhead sign area. Note that the respective inlet 31b in the light source unit 30 can be disposed behind the rear-side focal point F of the projection lens 20 by about 2.0 mm. The inlets 31b each can be sized to be slightly wider than the light-emitting device 33a (for example, 1 mm width in the horizontal direction and 1.5 mm in the vertical direction). The light (images of respective outlets 31_{c1} to 31_{c9} as the light sources) emitted from the light source unit 30 (respective outlets 31_{c1} to 31_{c9}) can be projected through the projection lens 20 including the standard lens surface 21a and the gradually varied lens surface 21b forward (see FIG. 17A to 18B and 21). In this manner, the light distribution patterns P1L and P1R including a plurality of irradiated areas A₁ to A₉ arranged side by side in the horizontal direction can be formed on the virtual vertical screen (see the previous exemplary embodiment shown in FIGS. 10B and 10C). In this case, the plurality of irradiated areas A₁ to A₉ can be individually controlled in light intensity. The light distribution patterns P1L and P1R can be substantially the same as that shown in FIG. 24B as well as the same as those the previous exemplary embodiment can form (see FIGS. 10A to 10D and 11A to 11C), and the description therefor is omitted here.

Next, a description will be given of the low beam light distribution pattern P2 formed by the lighting unit 70 dedicated to form the low beam. As shown in FIG. 10A, the low beam light distribution pattern P2 can be a left side light distribution pattern and have a cut-off line CL with the stepped upper end edge (CLR+CLL+CLS) as in the previous exemplary embodiment. The plurality of irradiated areas A₁ to A₉ (light-emitting devices 33a) can be controlled to be turned off or their outputs can be reduced by the same or similar method as in the previous exemplary embodiment. (See FIGS. 11A to 11C). As described above, in the present exemplary embodiment, the light rays RayA projected through the gradually varied lens surface 21b can be refracted by the action of the plurality of curves C_{L0} to C_{L90} and C_{R0} to C_{R90} with gradually increasing degree of upward refraction as being closer to the lower side of the lens 20 (see FIGS. 21A to 23B). With this configuration, without deteriorating the light utilization efficiency, the longitudinally long light distribution pattern vertically enlarged can be formed on the virtual vertical screen as shown in FIG. 24B with the luminous distribution of the upper portion constantly varied without unevenness. In the present exemplary embodiment, the partition between the adjacent outlets (for example, the outlets 31_{c1} and 31_{c2}) among the outlets 31_{c1} to 31_{c9} of the plurality of tube portions 31 is not formed of a thick wall portion (the thick wall portion B in FIG. 1), but an edge wall E with almost negligible width. Accordingly, the plurality of outlets 31_{c1} to 31_{c9} partitioned by the thin edge wall E (or luminance distribution formed by the outlets 31_{c1} to 31_{c9}) can be inverted and projected forward by the action of the projection lens 11 (see FIG. 6B). The use of a single lighting unit 10 can prevent or lower the gap (or darkened area) between the plurality of the irradiated areas A₁ to A₉ that can be adjusted by individually controlling the light-emitting devices. In contrast to this, the conventional lighting device adds another lighting unit for irradiating the gap (or darkened area) between the plurality of the irradiated areas. Accordingly, the presently disclosed subject matter does not need such an additional lighting unit separately. In the present exemplary embodiment, the plurality of light-emitting devices 33a can be arranged in line in the horizontal direction while the light-emission surface is directed forward (see FIG. 15). Accordingly, when compared with the case where a plurality of light—emitting devices are dispersedly arranged in the optical axis AX (see the plurality of light-emitting devices 230 in FIG. 1), a lighting unit with a shorter size in the optical axis AX direction can be configured. In the present exemplary embodiment, the light emitted from the light-emitting device 33a (light rays Ray2 emitted in a wider angular direction with respect to the optical axis AX) can enter the plurality of tube portions 31 and be reflected once and exit through each outlet 31_{c1} to 31_{c9}. Further, the plurality of tube portions 31 (reflectors 31a) can be configured to be a pyramidal shape narrowed from the outlets 31 to the inlet 31b (see FIG. 6B). The action of the tube portions 31 (reflectors 31a) can cause not only the light rays Ray1 in a narrower angular direction with respect to the optical axis AX but also light rays Ray2 in a wider angular direction with respect to the optical axis AX to enter the projection lens 11. Accordingly, the light utilization efficiency can be improved. In the present exemplary embodiment, the lighting units can be composed of less number of parts because a plurality of reflectors are not used (when compared with the case where a plurality of reflectors 220 are used as shown in FIG. 1). In the present exemplary embodiment, a plurality of light-emitting devices 33a can be mounted on the same substrate 33. Accordingly, the plurality of light-emitting devices 33a can be united and easily assembled when compared with the case where a plurality of light emitting devices are not mounted on the same substrate but dispersedly arranged in the optical axis AX direction (a plurality of reflectors 220 are used as shown in FIG. 1). In addition, the positioning of the plurality of light-emitting devices 33a to the plurality of tube portions 31 can be performed with higher accuracy. In the present exemplary embodiment, the images of the plurality of light-emitting devices 33a are not directly projected but light images appearing at the outlets 31_{c1} to 31_{c9} of the light guide member 32 are inverted and projected. Accordingly, when compared with the configuration where the images of the plurality of light-emitting devices 33a are directly projected, the distance between the plurality of light-emitting devices 33a can be widened. This configuration can alleviate the adverse effect of heat generated from the light-emitting devices 33a.

Exemplary Variations will be described next.

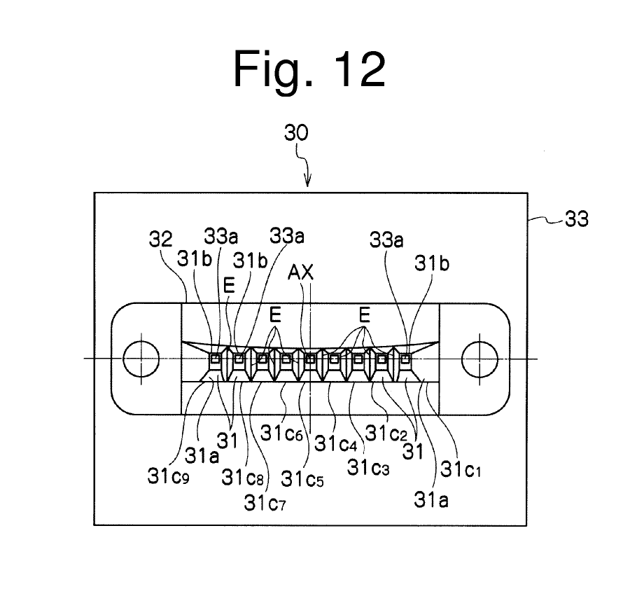

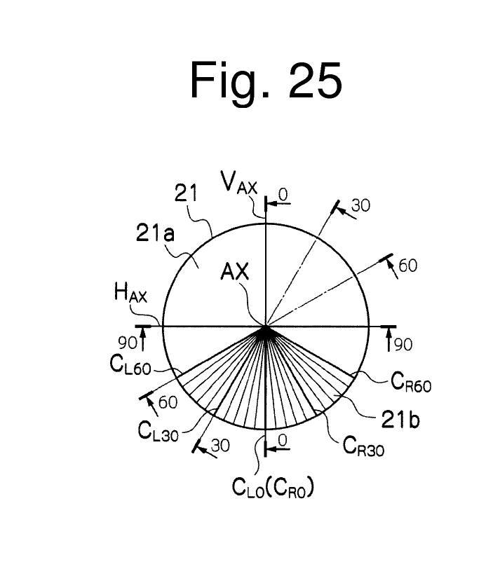

The lower end edges of the outlets 31_{c1} to 31_{c9} can extend in an arc shape when viewed from front in order to allow the height of the plurality of irradiated areas A₁ to A₉ on the virtual vertical screen to be small at a farther position and gradually be enlarged at a nearer position. The presently disclosed subject matter can take other modes. For example, as in the previous exemplary embodiment, the lower end edges of the outlets 31_{c1} to 31_{c9} can linearly extend in the horizontal direction when viewed from front as shown in FIG. 12. In the above exemplary embodiments, nine light-emitting devices 33a with a light-emission surface in a 0.7-mm square shape are used. But this is not limitative. The number and the shape of the light-emitting device can be appropriately selected according to the desired luminance, areas to be illuminated, standards and the like. The tube portions 31 in the above exemplary embodiments are hollow to constitute the lighting unit 10, but this is not limitative. For example, the plurality of tube portions can be replaced with solid lens bodies with a pyramidal shape having one end face as the inlet 31b and the other end face as the outlet 31_{c1} to 31_{c9}, and an outer peripheral surface an inside surface of which can serve as the reflector 31a, and narrowed from the outlet to the inlet. With this configuration, the same advantageous effects as in the previous exemplary embodiments can be obtained. In the above exemplary embodiment, the gradually varied lens surface 21b can be arranged on a lower side of the projection lens 20 with respect to the boarder horizontal plane H_{AX} including the optical axis AX of the projection lens 20 (see FIG. 24A), but this is not limitative. For example, the gradually varied lens surface 21b can be provided to part of the lower surface. FIG. 26 shows one example of the gradually varied lens surface 21b configured such that the relation of the curvatures is (the curvature of the curved line C_{L0} (C_{R0}) (see FIGS. 24(b) and 25(a))<(the curvature of the curved line C_{L30} (C_{R30}) (see FIGS. 24(c) and 25(b))<(the curvature of the curved line C_{L60} (C_{R60}) (see FIGS. 24(d) and 25(c))=the curvature of the standard lens surface 21a. It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A projector type lighting unit that is applicable to a vehicle headlamp, the projector type lighting unit comprising:
a projection lens having an optical axis, a rear-side focal point positioned on the optical axis, an incident surface, and an exiting surface;
a light source disposed substantially at the focal point of the projection lens, an image of the light source being projected through the projection lens during operation of the light source; and
a light path adjusting unit configured to diffuse part of the image of the light source in an upward direction when the lighting unit is installed in a vehicle light.

2. The projector type lighting unit according to claim 1, wherein
the light path adjusting unit is disposed in between the projection lens and the rear-side focal point of the projection lens, and is a reflector having a planar minor inclined with respect to a plane perpendicular to the optical axis of the projection lens toward the projection lens by substantially 45 degrees; and
the light source is disposed substantially at a position plane-symmetrical to the rear-side focal point with respect to the planar minor, and the reflector includes a reflection area concavely curved with respect to the light source to diffuse an upper portion of the image of the light source to be projected by the projection lens upward.

3. The projector type lighting unit according to claim 1, wherein
the light path adjusting unit is configured as the projection lens including a standard lens surface with a given curvature disposed on an upper side of the projection lens with respect to a boarder as a horizontal plane including the optical axis of the projection lens and a gradually varied lens surface disposed on a lower side of the projection lens, and
the gradually varied lens surface is configured such that a plurality of curvatures of curves appear on crossing lines between a plurality of planes and the gradually varied lens surface, the plurality of planes including the optical axis of the projection lens and inclined by different inclined angles with respect to a vertical plane including the optical axis of the projection lens, and the plurality of curvatures are equal to or less than a curvature of the standard lens surface and gradually increase from the vertical plane to the horizontal plane.

4. The projector type lighting unit according to claim 1, wherein
the light source includes,
a plurality of tube portions each having one end as an inlet and an other end as an outlet, and a reflector formed on an inner peripheral surface, and
a plurality of light-emitting devices each configured to emit light entering a respective tube portion via the inlet and exiting through the outlet,
the outlets of the plurality of tube portions are arranged side by side in line in a direction perpendicular to the optical axis of the projection lens and in a horizontal direction and disposed substantially at the rear-side focal point of the projection lens,
adjacent outlets among the outlets of the plurality of tube portions include a common edge wall that partitions the adjacent outlets, and
the plurality of tube portions have a pyramidal shape narrowed from the outlet to the inlet.

5. The projector type lighting unit according to claim 2, wherein
the light source includes,
a plurality of tube portions each having one end as an inlet and an other end as an outlet, and a reflector formed on an inner peripheral surface, and
a plurality of light-emitting devices each configured to emit light entering a respective tube portion via the inlet and exiting through the outlet,
the outlets of the plurality of tube portions are arranged side by side in line in a direction perpendicular to the optical axis of the projection lens and in a horizontal direction and disposed substantially at the rear-side focal point of the projection lens,
adjacent outlets among the outlets of the plurality of tube portions include a common edge wall that partitions the adjacent outlets, and
the plurality of tube portions have a pyramidal shape narrowed from the outlet to the inlet.

6. The projector type lighting unit according to claim 3, wherein
the light source includes,
a plurality of tube portions each having one end as an inlet and an other end as an outlet, and a reflector formed on an inner peripheral surface, and
a plurality of light-emitting devices each configured to emit light entering a respective tube portion via the inlet and exiting through the outlet,
the outlets of the plurality of tube portions are arranged side by side in line in a direction perpendicular to the optical axis of the projection lens and in a horizontal direction and disposed substantially at the rear-side focal point of the projection lens,
adjacent outlets among the outlets of the plurality of tube portions include a common edge wall that partitions the adjacent outlets, and
the plurality of tube portions have a pyramidal shape narrowed from the outlet to the inlet.

7. The projector type lighting unit according to claim 4, wherein the plurality of tube portions are each composed of a solid lens body with a pyramidal shape having one end face as the inlet and the other end face as the outlet, and an outer peripheral surface having an inside surface serving as the reflector, and being narrowed from the outlet to the inlet.

8. The projector type lighting unit according to claim 5, wherein the plurality of tube portions are each composed of a solid lens body with a pyramidal shape having one end face as the inlet and the other end face as the outlet, and an outer peripheral surface having an inside surface serving as the reflector, and being narrowed from the outlet to the inlet.

9. The projector type lighting unit according to claim 6, wherein the plurality of tube portions are each composed of a solid lens body with a pyramidal shape having one end face as the inlet and the other end face as the outlet, and an outer peripheral surface having an inside surface serving as the reflector, and being narrowed from the outlet to the inlet.

10. A projector type lighting unit comprising:
a projection lens having an optical axis, a rear-side focal point positioned on the optical axis, an incident surface, and an exiting surface;
a light source disposed substantially at the focal point of the projection lens, an image of the light source being projected through the projection lens during operation of the light source; and
a light path adjusting unit configured to diffuse part of the image of the light source in an upward direction when the lighting unit is operated.

11. The projector type lighting unit according to claim 10, wherein
the light path adjusting unit is disposed in between the projection lens and the rear-side focal point of the projection lens, and is a reflector having a planar minor inclined with respect to a plane perpendicular to the optical axis of the projection lens toward the projection lens by substantially 45 degrees; and
the light source is disposed substantially at a position plane-symmetrical to the rear-side focal point with respect to the planar minor, and the reflector includes a reflection area concavely curved with respect to the light source to diffuse an upper portion of the image of the light source to be projected by the projection lens upward.

12. The projector type lighting unit according to claim 10, wherein
the light path adjusting unit is integrated in the projection lens and includes a standard lens surface with a given curvature at a top portion of the projection lens, and a gradually varied lens surface different from the standard lens surface is disposed on a lower side of the projection lens, and
the gradually varied lens surface is configured such that a plurality of curvatures of curves appear on crossing lines between a plurality of planes and the gradually varied lens surface, the plurality of planes including the optical axis of the projection lens and inclined by different inclined angles with respect to a vertical plane including the optical axis of the projection lens, and the plurality of curvatures are equal to or less than a curvature of the standard lens surface and gradually increase from the vertical plane to the horizontal plane.

13. The projector type lighting unit according to claim 10, wherein
the light source includes,
a plurality of tube portions each having one end as an inlet and an other end as an outlet, and a reflector formed on an inner peripheral surface of each of the tube portions, and
a plurality of light-emitting devices each configured to emit light into a respective one of the tube portions via the inlet and exiting through the outlet,
the outlets of the plurality of tube portions are arranged side by side in line in a direction perpendicular to the optical axis of the projection lens and in a horizontal direction and disposed substantially at the rear-side focal point of the projection lens,
adjacent outlets among the outlets of the plurality of tube portions include a common edge wall that partitions the adjacent outlets, and
the plurality of tube portions have a pyramidal shape narrowed from the outlet to the inlet.
